(19) United States
(12) Patent Application Publication
(10) Pub. No.: US 2011/0161173 A1
(43) Pub. Date: Jun. 30, 2011

(54) Apparatus and method for targeted display advertising in a multimedia environment

(76) Inventor: Michael Robbins, Bellevue, WA (US)

(21) Appl. No.: 12/979,400

(22) Filed: Dec. 28, 2010

Related U.S. Application Data
(60) Provisional application No. 61/284,860, filed on Dec. 28, 2009.

(51) Int. Cl. G06Q 30/00

(52) U.S. Cl. 705/14.55; 705/14.73; 705/14.66

(57) ABSTRACT

Methods and systems for providing advertising content online, through handheld devices or interactive digital television where the user selects the commercial desired from a list. The audiovisual advertisement is only served when the user selects the specific commercial to watch in order to gain free access to content or services.

### CROSS-REFERENCE TO RELATED APPLICATIONS

Not Applicable.

### STATEMENT REGARDING FEDERALLY SPONSORED RESEARCH OR DEVELOPMENT

Not Applicable.

### FIELD OF THE INVENTION

Interactive audiovisual digital advertising

### TECHNICAL FIELD

The present invention relates to computer, mobile and television environments. More particularly, embodiments of the present invention relate to systems and methods for generating a list of audiovisual ads personalized for each individual from data mining. The individual must select a commercial to watch, and it will be delivered by streaming technology. Only when the commercial is over, will the user gain access to the content or services requested.

### BACKGROUND OF THE INVENTION

Marketers have long been trying to improve the monetization of internet advertising with better targeting. Whereas the search engine environment provides for 1:1 advertising based on the search string entered, display advertising does not have this benefit.

To improve banner targeting, marketers have taken to evaluating the user's cookies, browser history and reading their email. Even though the email reading is done automatically with software for instant ad placement, concerns over privacy have resulted in a Federal Trade Commission (FTC) proposal to limit what kind of information can be taken from users' computers. On Dec. 3, 2010, CNNMoney ran the headline “FTC ‘do not track’ plan would cripple some Web giants.” This statement suggests a lack of alternatives such as that brought by forward by the present invention.

The pay-per-click search engine market has been lucrative partially due to its ability to serve ads on an individual basis. When someone enters a query into a search engine, the text link ads are served based on the keywords entered in the search query. The variety of possible search queries is far greater than the variety of demographics known from a registration profile, geo-targeting and categorization based on content. The relevance of individualized pay-per-click ads drives higher response and conversion rates, which in turn provide crucial return on investment objectives to search engine marketers.

Display advertising online is often sold on a cost-per-impression or a cost-per-sale basis. When advertisers pay based on the number impressions their brand receives, the advertisers will often still track the click-through-rate and the amount of purchases that appear to result from the campaign, if applicable. Poor performance or exorbitant pricing of pay-per-impression ads has led to a growing cost-per-sale or affiliate market, whereby advertisers only pay when a user clicks through an ad and makes a purchase. The affiliate market has helped solve marketers' need to justify the return on investment for a campaign, but it still leaves the website or content portal guessing what ad should be displayed. Affiliate websites tend to search for affiliate ads by the category of the advertiser: electronics, real estate, crafts, etc.

Improvement in this area has been limited to sites dynamically serving display ads based on the user's geography, implied through IP address resolution or a questionnaire, or by targeting based on the user's past behavior. This may involve the site automatically reviewing the cookies in a users' browser, and dynamically serving an ad expected to be appealing. Tracking and harvesting such behavior is somewhat controversial and opposed by privacy advocates.

### SUMMARY OF THE INVENTION

The present invention is in the technical field of digital advertising. Online, mobile and television display advertising lacks the critical ability to serve more targeted, relevant commercials to viewers, while at the same time having fewer privacy violations. In addition to improving ad performance with targeting, affiliate advertising eliminates substantial risk and uncertainty for advertisers. This is why even small publishers can sign hundreds of affiliate advertisers in a week through automated networks. Television and online video advertising has traditionally been paid on a per impression basis, but these lucrative commercials to publishers also tend to be ephemeral, campaign-based. The economic weakness of 2009 increased the accountability of advertising budgets and hence strengthened interest in commission-based affiliate advertising.

In addition to distinguishing different advertising payment models, the present invention distinguishes its applicability to certain types of display advertising. Display advertising online comes in several forms: banner ads, pop-ups, DHTML, embedded video, interstitials and pre-rolls. The first three generally do not require user interaction to initiate the ad. The last three types of ads typically do require user interaction to begin. This interaction is made to get content, and an ad is positioned between the click and content delivery. Given that users are already accustom to clicking or interacting, the present invention effectively changes the ‘play’ button into a list of advertisers. To reduce unnecessary clicking, the play button presents the advertiser list upon a mouse rollover. To further simplify the experience, each advertiser is signified with words and graphics. Upon selection, the commercial is played through completion, at which time it disappears or forwards the user to the page requested.

The present invention provides for user selected advertisements based on product or category, which are played individually and separately in order to grant free access to content or services.

The present invention serves audiovisual advertisements based upon the user's selection. The user is asked to select the commercial he or she must watch in order to access free content or services in a web, mobile or interactive digital television environment. The user may select the ad from a list, which may resemble a dropdown field in a web environment, and can be created based on network, site or user-specific data collected. The preferred embodiment would build a list of intelligent suggestions, with the optional ability for the user to browse the entire ad inventory by category.

### BRIEF DESCRIPTION OF DRAWINGS

FIG. 1 is a flow chart describing the present invention.

### DETAILED DESCRIPTION OF THE INVENTION

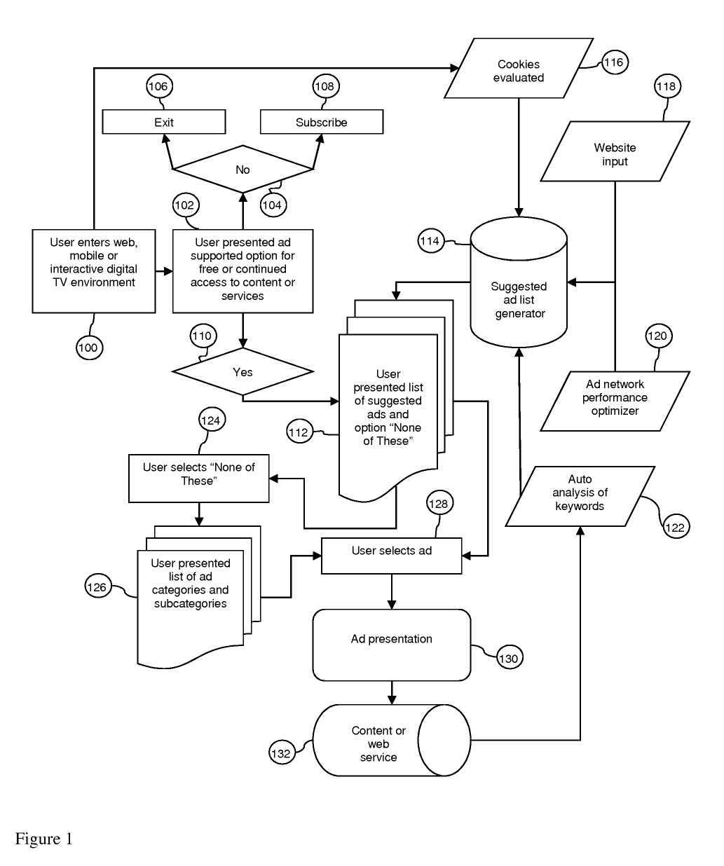

Referring now to the invention in more detail, in FIG. 1, there is a flow chart that illustrates the invention. The user arrives at website, channel or mobile portal 100, and desires access to more than what is immediately available. The embodiment of the invention in FIG. 1 does not necessarily begin at the home page, as it may be presented prior to accessing the home page, or withheld until a later or deeper point.

The user may be presented with an option to subscribe or pay for access to content or services 102 instead of reaching said content or services through advertising. If the user chooses not 104 to initiate the advertisement, then two alternatives will generally be present.

The first alternative may be to simply exit 106 the decision making process or window. It need not terminate the primary window. The window may or may not be a separate browser window or DHTML mouseover box. The exit 106 of the system may be when the user chooses to not watch an ad or subscribe, or when the subscribe option is not available.

The second alternative may be to pay a fee 108 to access such content or service. It may be a one time payment or a recurring subscription fee. The payment 108 may reduce the length, frequency or intrusiveness of subsequent advertising.

Should the user elect for the advertisement 110, the user is presented with a list of ads to choose from 112. In a rudimentary form, every user chooses from the same list. In the preferred embodiment, each user is presented a customized list 112, which is created from a number of inputs managed by a suggested ad list generator 114. The list generator has the capability of developing a list of ads specific for each user. An algorithm manages various inputs and weighs them according to importance.

One input is the user's cookies 116. Upon arrival 100 at the site coordinating access to content or services, which may actually be hosted elsewhere, certain information will be automatically evaluated, such as the user's cookies 116 or cached registration data. Cookies provide information about sites a user has visited and registration data. This information can be processed 114 to help determine what advertisements to which the user would most likely respond.

The information extracted by cookies is one of several inputs sent to the advertisement list generator 114.

The ad list generator may also receive input from the website, content, service provider, WAP location or channel 118, upon the content or service provider's registration. When registering, known demographic data on its average user may be entered 118, and it may be automatically collected with meta tags 118. The registration form also allows the portal to input descriptions of the information or interests presented within the portal. This information can be used to autosuggest a black list for the portal, which can also select competing brands or product categories to omit from the ad list presented to users.

The ad network performance optimization input 120 provides the ad list generator 114 information on commercials that pay the most money. This may be a combination of their popularity and value per impression, or the average estimated earnings per click when an ad pays as a result of the user clicking through and making a purchase.

The ad list generator 114 also receives input by analyzing the content or service to which the user will land after the advertisement 122. This can be done by using meta tags from websites, or audio analysis of video content to suggest ads based on the content sought.

Should the user choose to gain free access to content or services 110, the user is presented a list of commercials to choose from 112. These may be ordered alphabetically or by the estimated ranking of preferences. The ads may be listed by category or by the brand name of the advertiser. The list may contain the selection “None of These,” which by selecting 124 brings the user to a larger database of advertisers or advertisement categories 126.

Regardless of whether the “None of These” option is selected, when the desired commercial is selected 128, the media asset is pulled from a server to play 130 for the user. The user's selection is stored for future reference 116 so the ad selected or those like it can be served in the first list of suggested commercials. Upon completion or the appropriate keystroke, the user is transferred or given access rights to the content or service initially sought 132.

Depending on the configuration, this sequence may be repeated.

The invention claimed is:

1. An internet, mobile and television advertising system for presenting a list of three or more audiovisual advertisements

2. The advertising system of claim 1 wherein each list is personalized for each user by pulling information from a plurality of sources

3. The advertising system of claim 1 wherein the network file server delivers a predetermined number of advertisement listings based on the node, affiliate or user.

4. The advertising system of claim 1 serves the audiovisual commercial when it is selected by the user

5. The advertising system of claim 1 that only provides access to desired content or services when the ad selected is played and completed
